(19) United States
(12) Patent Application Publication
(10) Pub. No.: US 2003/0126271 A1
(43) Pub. Date: Jul. 3, 2003

(54) Method and apparatus for enabling an external function from a WAP environment

(76) Inventors: Kevin Curtis Mowry, Irving, TX (US); James B. McGuire, Delray Beach, FL (US); Jonathan James Main, Upton Grey (GB)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/033,014

(22) Filed: Dec. 27, 2001

(51) Int. Cl. G06F 15/16; H04B 7/00

(52) U.S. Cl. 709/230; 370/310

(57) ABSTRACT

A wireless communication device (10) operates using a Wireless Application Protocol (WAP) operating environment for enabling various data services. The wireless communication device (10) includes an application manager (22) coupled to the WAP operating environment that is operable to receive from the WAP operating environment a request to launch an external application. The application manager (22) operates launch the external application and to generate a handle. The handle is configured to control the external application within the WAP operating environment and is returned to the WAP operating environment responsive to the request to launch the external application. A library is associated with the external application, and the library includes information to configure the external application to operate within the WAP operating environment.

### FIELD OF THE INVENTION

The invention relates generally to wireless web applications, and more particularly to a method and apparatus for enabling an external environment or application within a wireless application protocol (WAP) environment.

### BACKGROUND OF THE INVENTION

Wireless communication networks, such as cellular telephone communication networks, are commonplace. Wireless communication networks may comply with one or more standards or recommendations, such as the Global System for Mobile communication (GSM), code division multiple access (CDMA), time division multiple access (TDMA), General Packet Radio Service (GPRS), 3^{rd} Generation Cellular (3G) and various evolutions and modifications of these standards. The structure and function of networks constructed in accordance with one or more of these standards are well defined by the governing standard. Having evolved from networks dedicated primarily to voice communication, wireless communication networks provide a broad range of services such as voice and data communication services including Internet, email and other packet data services.

Like the communication network, the mobile stations, the equipment used to access communication services via the communication network must comply with standards and requirements. These standards and requirements define the physical aspect of the communication link between the mobile station and the communication network as well as the form of the data and information to be communicated via the communication link. In addition to the standards governing the manner in which the mobile station communicates with the communication network, there further exist standards relating to the implementation of functionality within the mobile station.

The Wireless Application Protocol (WAP) is a communication protocol and an application environment that is designed to work with most wireless communication networks. WAP provides service interoperability over a wide range of devices and applications. Particularly, WAP enables wireless access to services such as Internet information in consideration of the limitations of the wireless communication environment, such as screen size, graphics capability, bandwidth and the like.

As mentioned above, WAP defines both an application environment as well as a communication protocol. Thus, applications are created specifically to execute within the WAP environment. A typical WAP application consists of Wireless Markup Language (WML) and WML Script. As a result, applications not created for the WAP environment are incompatible and cannot be executed within the WAP environment. To expand the feature offerings available within the WAP environment, it has been contemplated to provide an External Functionality Interface (EFI). The purpose of the EFI is to provide a standard way of discovering external functionality outside of the WAP environment, whether resident inside or outside the mobile station. However, neither the WAP standard nor the EFI define the interaction between the WAP environment and the external functionality, and particularly the external application.

Thus, there is a need for a method and apparatus for enabling an external functionality from within the WAP environment.

### BRIEF DESCRIPTION OF THE DRAWINGS

FIG. 1 is a block diagram of a WAP enabled communication device that may be adapted in accordance with the preferred embodiments of the invention.

FIG. 2 is a block diagram illustrating the process by which an external environment is enabled with a WAP environment according to the preferred embodiments of the invention.

FIG. 3 is a flow chart illustrating a method for enabling an external environment from within a WAP environment in accordance with a preferred embodiment of the invention.

### DETAILED DESCRIPTION OF THE PREFERRED EMBODIMENTS

A wireless communication device includes a Wireless Application Protocol (WAP) operating environment (a “WAP browser”) that is capable of executing WAP applications. A WAP application running within the WAP browser is able to discover, launch and control external applications, such as JAVA applications. The external application is executed in an external environment separate from the WAP application environment. To interact with the WAP environment, the external application must initiate a connection to the WAP application, which is accomplished via an external function interface (EFI). The EFI, in turn, provides a handle to the connection back to the WAP application. The handle is used by the WAP application to control the external application, e.g., suspend, resume or terminate it, or to send information to or receive information from the external application.

The external application must initiate a connection to the EFI. This may be accomplished in a number of ways, including incorporating code directly into the external application that initiates the connection or invoking a library call from the external application that establishes the connection.

A method for executing an external application from a WAP application is also provided. The method includes the steps of establishing a connection from the external application to the WAP application via an EFI and providing an handle to the WAP application for controlling the external application. The connection may be established by incorporating code directly into the external application that initiates the connection or by invoking a library call form the external application that establishes the connection.

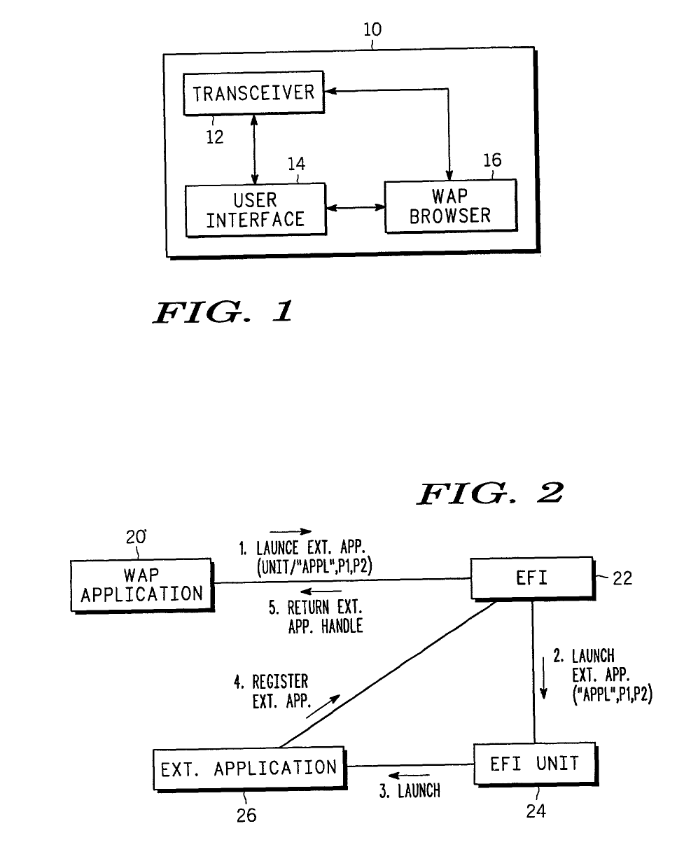

Referring to FIG. 1, a wireless communication device 10 is configured to operate in accordance with one or more wireless communication standards. The wireless communication device 10 may be any type of device configured to access communication services from a servicing communication network including, without limitation, a cellular telephone, a pager, a wireless enabled personal digital assistant, a wireless enabled personal computer devices and the like. While the physical configuration of the wireless communication device is not particular to the present invention, such devices typically include a processor and a memory including a control program for directing the operation of the processor (not depicted) to enable operation of the wireless communication device 10 to access communication services from the communication network.

Functional elements of the wireless communication device 10 may include operatively coupled a transceiver 12, a user interface 14 and a WAP browser 16. The WAP browser may be implemented as computer code retained within a memory of the communication device 10 to direct the processor to operate in conjunction with the user interface 14 to provide a WAP operating environment. The WAP browser 16 functions consistently with the WAP standard to enable WAP application operation within the wireless communication device 10. The transceiver 12 provides the physical interface of the wireless communication 10 with the communication network using one or more communication resources. The user interface 14 may include an audio interface including a speaker and microphone, a graphic display and an input device such as a keypad, touch screen or voice interface.

On occasion, it may become necessary or desirable to enable an external function from within the WAP browser 16. For example, a WAP application may be provided within the wireless communication device 10 that provides to the user a navigation feature. To facilitate the navigation feature, the wireless communication device 10 needs to have available data reflecting its current location. An application could be written to operate within the WAP environment to determine the necessary location information. However, functions within the wireless communication device 10, but apart from the browser 16, are already capable of determining or acquiring location information, which is often necessary for proper operation of the wireless communication device 10 within the wireless communication network. Thus, it would be useful and advantageous to allow the WAP navigation application to access the location function of the wireless communication device 10.

Referring to FIG. 2, in order to invoke an external application from within the WAP environment, the WAP application 20, from within the WAP browser 16, sends a request to launch an external application (1) to an external function interface (EFI) 22. The request includes an identification of the requested application as well as any necessary parameters, e.g., p1 and p2, associated therewith. The WAP application 20 calling the external application may be any type of application including the navigation feature described above. In this manner, the WAP application 20 uses the EFI 22 to invoke the external application.

The EFI 22 sends a launch external application message (2) to an External Function (EF) unit 24 supporting the requested external application. The message may be a “handleInvoke” message indicating to the EF unit 24 to launch (3) the requested external application 26 and to return a handle. In order for the requested external application 26 to operate within the WAP environment, it is necessary for the external application 26 to establish a connection back to the EFI 22.

Once the requested external application 26 has established the connection to the EFI 22, the external application 26 is registered (4) with the WAP application. Additionally, a handle (5) is returned to the requesting WAP application 16. The handle provides the WAP application 16 the information necessary for it to control the external application. For example, the handle allows the WAP application 16 to suspend, resume or terminate operation of the requested application. The handle also allows the WAP application 16 to send information to and to receive information from the external application 16. The requesting WAP application 16 then uses the handle to manage the external function from within the WAP environment. For example, the external function may be an asynchronous call. The WAP application 16 may use the handle to inquire, via the EFI 22, the status of the external application 26 as well as to obtain any requested parameters to be returned from the external application 26. As will be appreciated, a handle is generated for each external application called by a WAP application, and each handle is made available to the corresponding requesting WAP application.

On initialization of the wireless communication device 10, the EFI 22 may identify available external functions and maintain a list of the available functions. The list allows the EFI 22 to send the launch message to the appropriate EF unit for launching the requested external application. If the requested external application is not contained on the list of external applications, an error message is returned to the requesting WAP application. Alternatively to identifying available external functions on device initialization, as a new external function is installed in the wireless communication device 10, the EFI 22 may identify the existence of the new external application and add it to the list. The EFI 22 may further periodically update the list.

A library may be provided as part of either the EF unit 24, the external application 26 or as a standalone element (not depicted). In essence, the library provides the information necessary to establish the connection between the external application and the requesting WAP application, which allows the external application to operate via the WAP browser 16 virtual machine (not depicted). The library information may be available generally for use by developers seeking to add WAP-enabled external applications on particular wireless communication devices. In the case of JAVA applications, for example, the external application may be written once, and adapted to run within the WAP environment on the virtual machine without modification by using the configuration information available in the library. Alternatively, the necessary configuration information may be written directly into the external application.

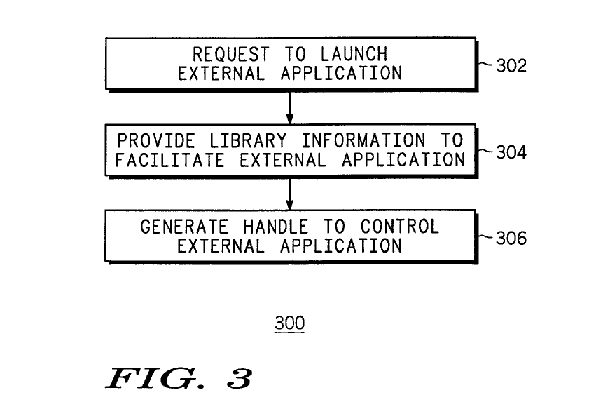

Referring to FIG. 3, a method for enabling an external application within a WAP environment begins at step 302 up receipt of a request from a WAP application to invoke an external application. In response to the request, at step 304, a library provides information necessary to configure the external application for operation from the WAP environment. At step 306, a handle is generated that permits the external application to be controlled from within the WAP application, and the handle is returned to the WAP application.

While the invention is susceptible to various modifications and alternative constructions, certain illustrative embodiments thereof have been shown in the drawings and are described in detail herein. It should be understood, however, that there is no intention to limit the disclosure to the specific forms disclosed, but on the contrary, the intention is to cover all modifications, alternative constructions and equivalents failing within the spirit and scope of the disclosure as defined by the appended claims.

We claim:

1. In a communication device including a wireless applications protocol (WAP) operating environment, an apparatus for enabling an external function from within the WAP operating environment comprising:
a external function interface coupled to the WAP operating environment and operable to receive from the WAP operating environment a request to launch an external application;
a handle configured to permit control of the external application from within the WAP operating environment, the handle being generated by the external function interface and returned to the WAP operating environment responsive to the request to launch the external application; and
a library associated with the external application, the library including information to initiate a connection between the external application and the WAP operating environment, wherein the handle corresponds to the connection.

2. The apparatus of claim 1, wherein the external function interface includes a list of external applications available to be launch from within the WAP operating environment.

3. The apparatus of claim 2, wherein the list of external applications is dynamically generated upon an initialization of the WAP operating environment on the communication device.

4. The apparatus of claim 2, wherein the list of external applications is dynamically generated on a periodic basis.

5. The apparatus of claim 1, wherein the external function interface comprises a plug-in to the WAP operating environment.

6. The apparatus of claim 1, wherein the handle comprises an instance identifier.

7. The apparatus of claim 1, wherein the library comprises code embedded within the external application.

8. The apparatus of claim 1, wherein the library is separate from and accessible by the external application.

9. The apparatus of claim 1, wherein the apparatus enables the WAP application to discover, launch and control the external application.

10. In a wireless communication network including a mobile station adapted according to the Wireless Applications (WAP) protocol to provide a WAP operating environment, a method for enabling an external function within the WAP operating environment comprising the steps of:
receiving from the WAP operating environment a request to launch an application external to the WAP operating environment;
generating a handle associated with the application, the handle being configured to permit control of the external application from within the WAP operating environment; and
providing a library associated with the external application, wherein the library includes information to initiate a connection between the external application and the WAP operating environment, wherein the handle corresponds to the connection.

11. The method of claim 10, comprising the step of generating a list of available external applications.

12. The method of claim 11, wherein the step of generating a list of available external applications comprises generating upon an initialization of the WAP operating environment a list of available external applications.

13. The method of claim 11, wherein the step of generating a list of available external applications comprises periodically updating the list of external applications.

14. The method of claim 10, wherein the step of generating a handle comprises generating a connection identifier, the connection being associated with the external application.

15. The method of claim 14, wherein the step of generating an instance identifier comprises providing the instance identifier to a register within the WAP environment.

16. The method of claim 10, wherein the step of providing a library associated with the external application comprises providing a library element and associating the library element with the external application.

17. The method of claim 10, wherein the step of providing a library associated with the external application comprises providing the information for facilitating the function of the external application within the external application.
